(19) United States
(12) Patent Application Publication
(10) Pub. No.: US 2015/0274024 A1
(43) Pub. Date: Oct. 1, 2015

(54) CHARGE TRANSFER METHOD AND RELATED ELECTRIC DEVICE

(71) Applicant: VALEO SYSTEMES DE CONTROLE MOTEUR, Cergy Saint Christophe (FR)

(72) Inventors: Jose-Louis Da Costa, Franconville (FR); Sébastien Dijol, Rosny Sous Bois (FR); Kamel Bouallaga, Basildon Essex (GB)

(73) Assignee: VALEO SYSTEMES DE CONTROLE MOTEUR, Cergy Saint Christophe (FR)

(21) Appl. No.: 14/435,210

(22) PCT Filed: Oct. 30, 2013
(86) PCT No.: PCT/FR2013/052603

§ 371 Date: Apr. 13, 2015

(30) Foreign Application Priority Data
Oct. 30, 2012 (FR) 1260366

(51) Int. Cl. B60L 11/18

(52) U.S. Cl. CPC B60L 11/1809

(57) ABSTRACT

The present invention relates to a method for transferring a charge from an electricity source to a battery means (21) of an electric device of a motor vehicle, said electric device including: a voltage converter (13) connected to the battery means (21), a capacitor connected to the voltage converter (13), a means for connecting the electric device, intended for being connected to the electricity source, a second voltage converter (14) connected between the first battery means (21) and the first converter (13) as well as to a second battery means (22). The method includes a step of connecting a means for connecting to the electricity source in order to enable a charge transfer towards the battery means (21). The method also includes a step of precharging the capacitor with a predetermined voltage from the voltage provided by the battery means (21) via the voltage converter (13), said precharging step being prior to the transfer of the charge from the electricity source to the battery means (21). During the precharging step, the second voltage converter (14) outputs, from the voltage supplied by the second battery means (22), an intermediate voltage from which the first voltage converter (13) precharges the capacitor at said predetermined voltage.

The present invention relates to the field of electric devices allowing transfers of a charge to accumulation means and more particularly electric devices arranged in motor vehicles.

The use of electric motors in motor vehicles involves the use of accumulation means for supplying power to the motor. The accumulation means for example are rechargeable batteries that can be recharged by a power source, such as a domestic network or a charging terminal. The adaptation between the power source and the accumulation means involves the use of electric devices allowing the transfer of a charge between the power source and the accumulation means. The proposed solutions include the use of a rectifier comprising inductors for converting an alternating voltage provided by the power source into direct voltage, the direct voltage then being transmitted to the battery via a voltage converter. With such an electric device a capacitor must be introduced between the rectifier and the voltage converter in order to adapt the two circuits and to transform the current source obtained at the output of the rectifier into a voltage source. With such a device, however, overcurrents may appear temporarily when the device is connected to the power source. Because the capacitor is discharged, a high current draw occurs during the connection to the power source. These overcurrents may lead to premature wear of the capacitor and may trigger external circuit breaker devices, which are activated in the event of overcurrent delivered by the power source. Likewise, if the power source is a direct current source, a capacitor is necessary in order to charge the accumulation means, and therefore overcurrents may also occur.

The object of the present invention is therefore to propose a solution that makes it possible to overcome the above-mentioned disadvantages of the prior art and to recharge the accumulation means without creation of overcurrents. In addition, in order to be applicable to the automotive field, the solution must be associated with a reduced cost and must therefore require a minimum of supplementary components.

The embodiments of the present invention thus relate to a method for transferring a charge from a power source to accumulation means of an electric device of a motor vehicle, said electric device comprising:
a voltage converter connected to the accumulation means,
a capacitor connected to the voltage converter,
connection means of the electric device, said connection means being intended for connection to the power source,
   the method comprising a step of connecting the connection means to the power source in order to enable a transfer of charge to the accumulation means and also comprising a step of pre-charging the capacitor to a predetermined voltage on the basis of the voltage provided by the accumulation means via the voltage converter, said pre-charging step being prior to the transfer of charge from the power source to the accumulation means.

In accordance with another aspect of the present invention, the predetermined voltage value corresponds to a voltage greater than or equal to the voltage obtained at the terminals of the capacitor during the charging of the accumulation means by the power source.

In accordance with an additional aspect of the present invention, the electric device also comprises a rectifier and inductors, said rectifier being connected on the one hand to the capacitor and on the other hand to the inductors, said inductors being connected to the connection means.

In accordance with a further aspect of the present invention, the switches of the rectifier are open during the pre-charging step.

In accordance with another aspect of the present invention, the rectifier is an H-bridge converter and the inductors comprise the phases of an electric motor.

In accordance with another aspect of the method of the present invention, said device further comprising a second voltage converter connected on the one hand between the first accumulation means and the first converter and on the other hand to second accumulation means, in the method the second voltage converter, during said pre-charging step, delivers, on the basis of the voltage provided by the second accumulation means, an intermediate voltage on the basis of which the first voltage converter pre-charges the capacitor to said predetermined voltage.

The embodiments of the present invention also concern an electric device of a motor vehicle comprising:
accumulation means,
a voltage converter connected to the accumulation means,
a capacitor connected to the voltage converter,
connection means of the electric device, said connection means being configured for connection to a power source so as to enable a transfer of charge to the accumulation means from said power source, and
   wherein the voltage converter is configured to pre-charge the capacitor to a predetermined voltage on the basis of the voltage provided by the accumulation means, prior to the charge transfer from said power source to the accumulation means.

In accordance with another aspect of the present invention, the predetermined voltage corresponds to a voltage greater than or equal to the voltage established at the terminals of the capacitor as the accumulation means are charged by the power source.

In accordance with a further aspect of the present invention, the electric device also comprises a rectifier and inductors, said rectifier being connected on the one hand to the capacitor and on the other hand to the inductors, said inductors being connected to the connection means.

In accordance with an additional aspect of the present invention, the rectifier is an H-bridge converter and the inductors comprise the phases of an electric motor.

In accordance with a further aspect of the present invention, the bridges of the converter comprise a first and a second branch, which are parallel, and a transverse branch, said parallel branches comprising two switches arranged in series, and said transverse branch comprising one of said inductors and connecting the middle points of said first and second parallel branches.

In accordance with an additional aspect of the present invention, the electric motor is a three-phase motor.

In accordance with another aspect of the present invention, the phases of the motor comprise a winding at the middle point and the connection means are connected at the middle points of the windings of the phases of the electric motor.

In accordance with another aspect of the present invention, the voltage converter is a DC/DC voltage converter and comprises two switches arranged in series between a first and a second input terminal, the middle point arranged between the two switches being connected to a first terminal of an inductor of which the second terminal is connected to a first output terminal, a second output terminal being connected to the second input terminal and to ground.

In accordance with a further aspect of the present invention, the accumulation means comprise a positive terminal connected to the first output terminal of the voltage converter and a negative terminal connected to the second output terminal of the voltage converter.

In accordance with an additional aspect of the present invention, the capacitor is branched between the first and the second input terminal of the voltage converter.

In accordance with another aspect of the present invention, the switches comprise a transistor with a diode in anti-parallel.

In accordance with another aspect of the present invention, the device further comprises a second voltage converter connected on the one hand between the accumulation means and the first converter and on the other hand to second accumulation means, wherein the second voltage converter is configured to deliver, on the basis of the voltage provided by the second accumulation means, an intermediate voltage on the basis of which the first voltage converter pre-charges the capacitor to said predetermined voltage.

In accordance with another aspect of the present invention, the first accumulation means are intended to supply power to an electric motor and the second accumulation means are intended to supply power to one or more electric consumers different from said electric motor.

In a particular embodiment compatible with the other aspects of the method or of the device of the invention, the switches of the rectifier are open during the pre-charging step. In particular, during the pre-charging, the capacitor is isolated from the power source merely thanks to the open state of the switches of the rectifier. Thus, in this particular embodiment, the method and the device do not require further switches in order to isolate the capacitor, the voltage converter and/or the accumulation means during the pre-charging. The switches used to isolate the capacitor, the voltage converter and/or the accumulation means from the power source are components of the rectifier, in particular switches belonging to the arms of the rectifier.

The invention also relates to a method for transferring a charge from a power source to accumulation means of an electric device of a motor vehicle, said electric device comprising:
a voltage converter connected to the accumulation means,
a capacitor connected to the voltage converter,
connection means of the electric device, said connection means being intended for connection to the power source,
a second voltage converter connected on the one hand between the first accumulation means and the first converter and on the other hand to second accumulation means,
   the method comprising a step of connecting the connection means to the power source in order to enable a transfer of charge to the accumulation means,
   characterized in that the method also comprises a step of pre-charging the capacitor to a predetermined voltage on the basis of the voltage provided by the accumulation means via the voltage converter, said pre-charging step being prior to the transfer of charge of the power source to the accumulation means, and in that, during said pre-charging step, the second voltage converter (14) delivers, on the basis of the voltage provided by the second accumulation means (22), an intermediate voltage on the basis of which the first voltage converter (13) pre-charges the capacitor (11) to said predetermined voltage.

The method may comprise any one of the features described above.

The invention also relates to an electric device of a motor vehicle, comprising:
accumulation means,
a voltage converter connected to the accumulation means,
a capacitor connected to the voltage converter,
connection means of the electric device, said connection means being configured for connection to a power source so as to allow a transfer of charge to the accumulation means from said power source,
a second voltage converter connected on the one hand between the accumulation means and the first converter and on the other hand to second accumulation means,
   characterized in that the voltage converter is configured to pre-charge the capacitor to a predetermined voltage on the basis of the voltage provided by the accumulation means, prior to the transfer of charge from said power source to the accumulation means, and in that the second voltage converter is configured to deliver, on the basis of the voltage provided by the second accumulation means, an intermediate voltage on the basis of which the first voltage converter pre-charges the capacitor to said predetermined voltage.

The device may comprise any one of the features described above.

The invention also relates to a method for transferring a charge from a power source to first accumulation means of an electric device of a motor vehicle, said electric device comprising:
a first voltage converter connected to the first accumulation means,
a capacitor connected to the first voltage converter,
connection means of the electric device, said connection means being intended for connection to the power source,
a second voltage converter connected on the one hand between the first accumulation means and the first converter and on the other hand to second accumulation means,
   the method comprising a step of connecting the connection means to the power source so as to allow a transfer of charge to the first accumulation means,
   the method also comprising a step of pre-charging the capacitor to a predetermined voltage, in which the second voltage converter delivers, on the basis of the voltage provided by the second accumulation means, an intermediate voltage on the basis of which the first voltage converter pre-charges the capacitor to said predetermined voltage.

In accordance with a variant of this transfer method, the method comprises, prior to the pre-charging step, a step of opening a switch arranged between on the one hand the first accumulation means and on the other hand the first and second converters so as to disconnect the first accumulation means from the other parts of the device.

The method may comprise any one of the features described above compatible therewith.

The invention also relates to an electric device of a motor vehicle, comprising:
first accumulation means,
a first voltage converter connected to the first accumulation means,
a capacitor connected to the first voltage converter,
connection means of the electric device, said connection means being configured for connection to a power source so as to allow a transfer of charge to the first accumulation means from said power source,
   the second voltage converter being configured to deliver, on the basis of the voltage provided by the second accumulation means, an intermediate voltage on the basis of which the first voltage converter is configured to pre-charge the capacitor to a predetermined voltage.

In accordance with a variant of this device, a switch is arranged between on the one hand the first accumulation means and on the other hand the first and second converters, said switch being configured to open prior to the pre-charging of the capacitor.

The device may comprise any one of the features described above compatible therewith.

Further features and advantages of the invention will emerge from the following description, provided with reference to the accompanying drawings, which illustrate a possible embodiment and are merely indicative, but not limiting.

In the drawings:

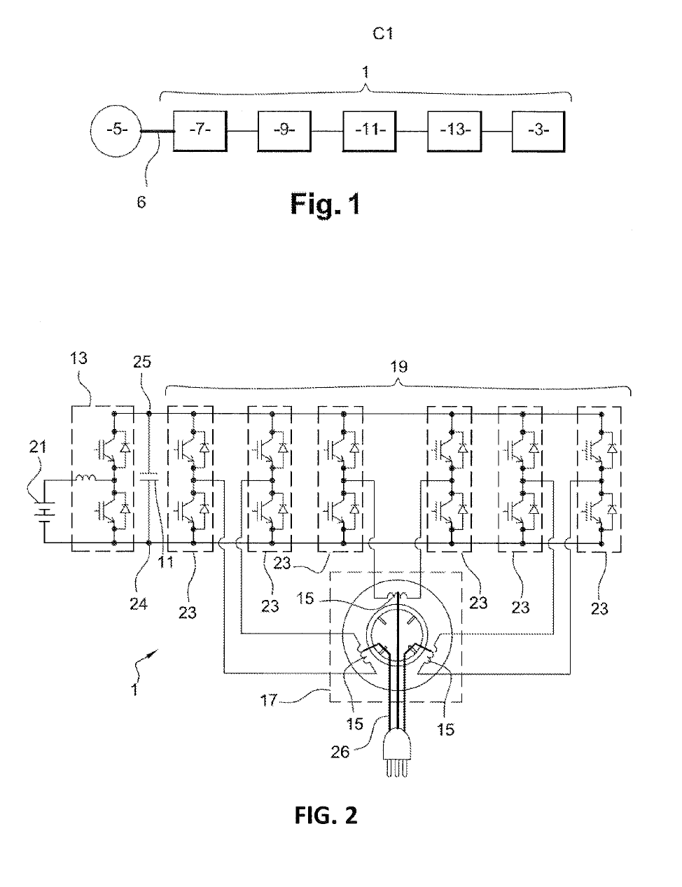

FIG. 1 shows a block diagram of an electric device in accordance with an embodiment of the present invention;

FIG. 2 shows a diagram of the components of an electric device in accordance with an embodiment of the present invention;

FIG. 3 shows a block diagram of an electric device in accordance with an embodiment of the present invention;

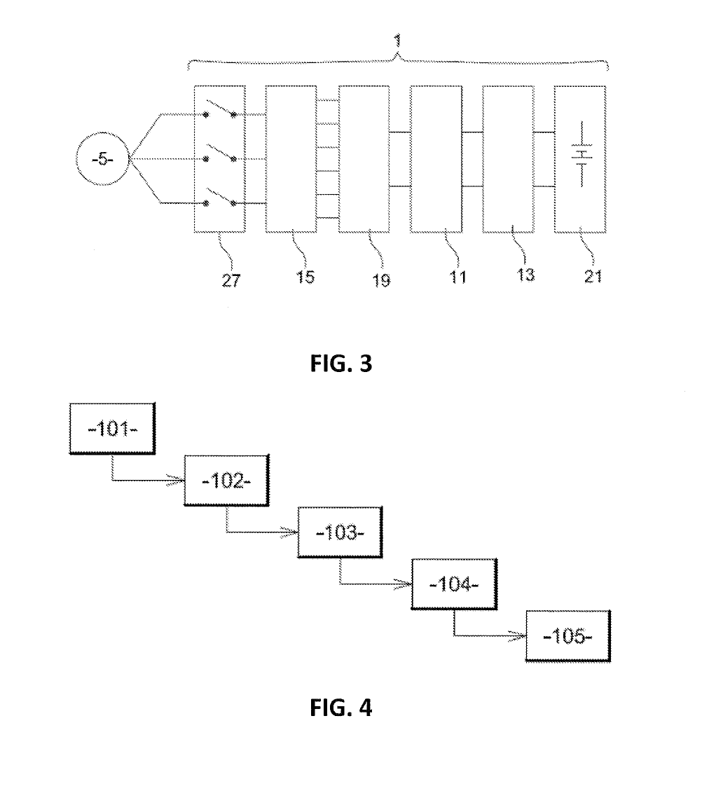

FIG. 4 shows a flowchart of the steps of a charge transfer method in accordance with an embodiment of the present invention;

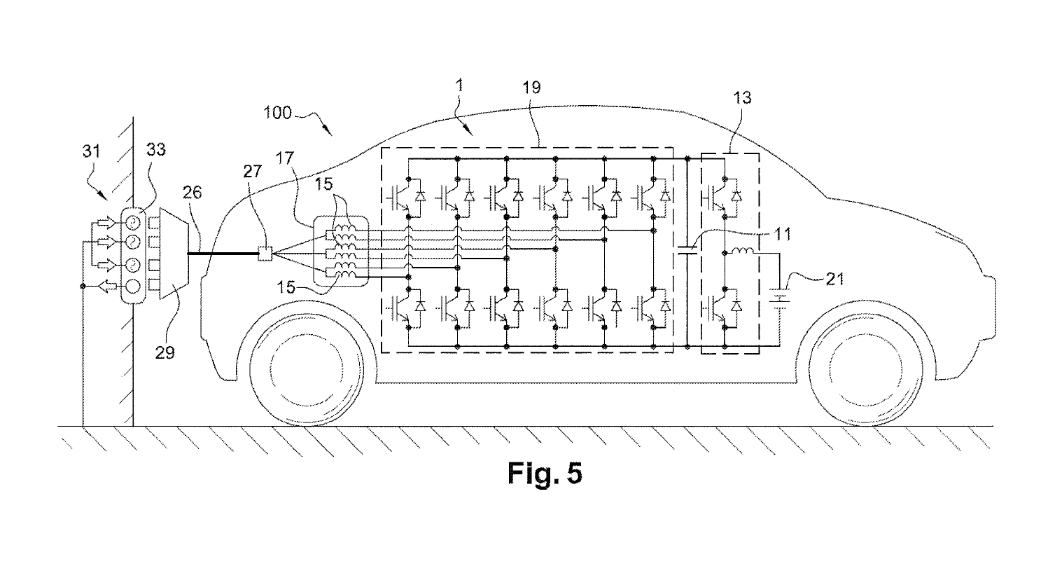

FIG. 5 shows a motor vehicle comprising an electric device in accordance with an embodiment of the present invention;

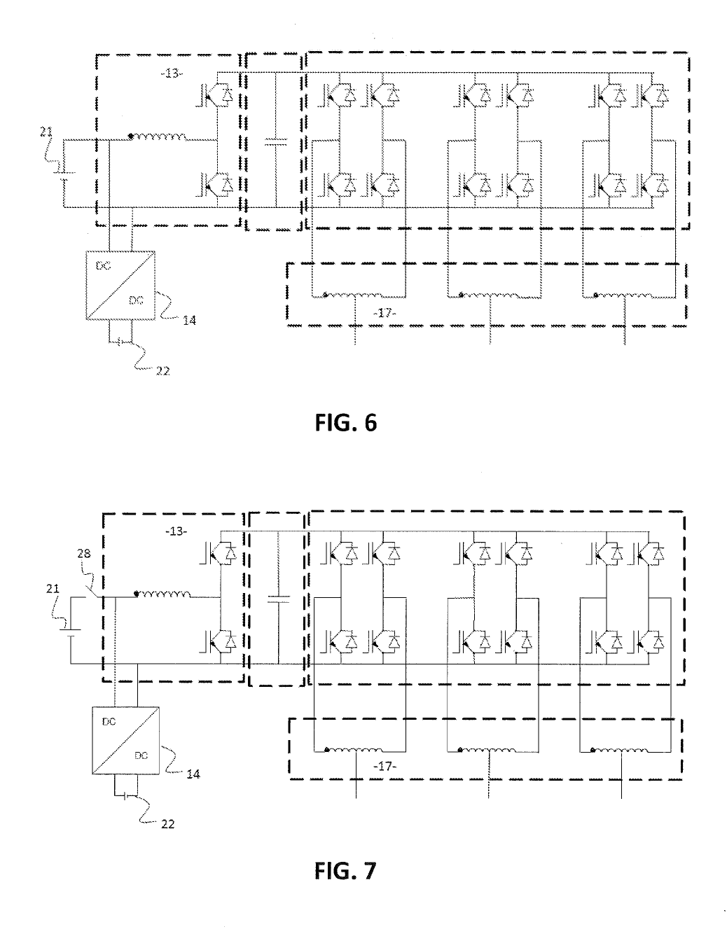

FIG. 6 shows a diagram of the components of an electric device in accordance with an embodiment of the present invention;

FIG. 7 shows a diagram of the components of an electric device in accordance with an embodiment of the present invention.

In these figures the same reference numerals denote identical components.

The following definitions are used generally in the following description:

The term “insulated gate bipolar transistor” (IGBT) corresponds to a hybrid transistor consolidating a metal-oxide semiconductor field effect transistor (MOSFET) at the input and a bipolar transistor at the output;

The term “reversible” associated with a converter (for example a rectifier or a voltage converter) defines the property of a converter to operate in both directions in terms of power (the inputs and outputs of the converter can also be outputs and inputs respectively);

The term “middle point” with reference to a coil, a winding or a phase relates to any intermediate point between the two ends of the winding. Nevertheless, this middle point is preferably located in the middle of the winding so as to balance the currents between the two half-coils and thus reduce the vibrations during charging cycles;

The term “battery” corresponds to a single battery or to a set of batteries connected to one another such that they can be charged simultaneously.

The embodiments of the present invention concern a method for transferring a charge from a power source to accumulation means of an electric device. The power source is arranged externally of the device, for example.

FIG. 1 shows a block diagram of the different components of the electric device 1 making it possible to connect the accumulation means 3 to the power source 5. The connection between the electric device 1 and the external power source is established by connection means 6, such as a power cable, referred to here as a charging cable, provided with a plug that can be connected to a complementary plug of the power source 5. The power source 5 for example is a three-phase alternating voltage source. However, the embodiments of the present invention are not limited to this type of power source, but also extend to other types of power source, such as a mono-phase voltage source. In addition, this power source 5 may be, inter alia, a domestic network, a terminal dedicated to the charging of electric accumulation means, a generator, or other accumulation means.

The electric device 1 comprises inductors 7, which are connected to the power source 5 via the charging cable 26. The inductors 7 are connected to a rectifier 9, which makes it possible to convert the alternating current output by the power source into direct current in order to supply power to the accumulation means 3. The rectifier 9 is connected to a DC/DC voltage converter 13 via a capacitor 11. The capacitor 11 allows an adaptation between the rectifier 9 and the voltage converter 13 in order to deliver a voltage to the accumulation means. Thus, the value of the capacitor 11 will depend on the properties of the accumulation means 3 and in particular the value of the nominal voltage of the accumulation means 3. The voltage converter 13 is connected to the accumulation means 3 and makes it possible to adapt the value of the voltage provided by the power source 5 to the nominal voltage value of the accumulation means 3. In order to avoid the appearance of overcurrents during the connection of the charging cable 26 to the power source 5, the electric device 1 is configured to apply a pre-charge to the capacitor 11 on the basis of the energy available at the accumulation means 3 via the voltage converter 13. To this end, the voltage converter 13 is preferably reversible so as to allow an energy transfer in both directions. In order to perform this pre-charge, switches at the charging cable 26 are used, for example. These switches are open during the connection of the charging cable to the power source 5 and remain open during the pre-charging of the capacitor 11. When the pre-charging is complete, the switches are then closed so as to allow the charging of the accumulation means 3. However, the switches used to isolate the circuit during the pre-charging may also be positioned other than at the charging cable. For example, the switches of the rectifier 9 can be opened during the pre-charging.

In accordance with an embodiment of the present invention shown in FIG. 2, the inductors 7 comprise phase windings 15 of a three-phase electric motor 17. The rectifier 9 can be provided by an H-bridge converter 19. The accumulation means 3 can be provided by a rechargeable battery 21. The converter 19 for example comprises three H bridges. A bridge comprises a first and a second branch 23, which are parallel and which are connected on the one hand to ground 24 and on the other hand to a contact point 25 of the electric device 1. Said parallel branches 23 may each comprise two switches arranged in series. The switches are formed for example by a transistor with a diode arranged in anti-parallel. The transistors for example are of the IGBT type. The bridge also comprises a transverse branch comprising a phase 15 of the motor connecting the middle points of said first and second parallel branches 23 arranged between the switches.

In addition, in the case of phases 15 at the middle point, the different terminals (corresponding for example to the three phases in the case of a three-phase power source) of the power source 5 can each be connected to a respective middle point of the phases 15.

The capacitor 11 is connected to ground 24 and to the contact point 25. The voltage converter 13 is a DC/DC voltage converter and comprises a primary branch, which is connected on the one hand to the contact point 25 at a first input terminal and on the other hand to ground at a second input terminal. The primary branch comprises two switches arranged in series. The switches are formed for example by a transistor with a diode arranged in anti-parallel. The transistors for example are of the IGBT type. The voltage converter 13 also comprises a secondary branch. The secondary branch comprises an inductor connected on the one hand to the middle point of the primary branch arranged between the two switches and on the other hand to a first output terminal of the voltage converter 13. The first output terminal is connected to a first terminal of the battery 21 corresponding to the positive terminal. The output terminal of the voltage converter 13 corresponds to ground 24 and is connected to the second terminal of the battery 21, that is to say the negative terminal.

Such an electric device 1 comprises reversible components, in particular the H-bridge converter 19 and the DC/DC voltage converter 13, such that this electric device can be used equally to charge the battery 21 when the phases 15 of the electric motor 17 are connected to a power source 5, and to supply power to the electric motor 17 from the battery 21, which makes it possible to limit the number of components necessary in the electric device 1 in the case of an electric motor intended to drive a motor vehicle.

A device similar to that of FIG. 2 can be used with a mono-phase power source 5. In this case only two phases 15 of the motor for example are connected to the two terminals of the mono-phase power source 5.

FIG. 3 shows a flowchart of the electric device of FIG. 2 to which switches 27 have been added between the power source 5 and the inductors 15 connected to the rectifier 19 so as to be able to control the power supply of the electric device 1 when the charging cable 26 is connected to the power source 5.

The different steps of the method allowing the charging of the accumulation means 3 are shown in FIG. 4 and will be described on the basis of the flowchart of FIG. 3. In accordance with an embodiment of the present invention, the accumulation means 3 comprise a rechargeable battery 21.

It should be noted that the implementation of the embodiments of the present invention requires a minimum level of charge of the battery 21 in order to allow the pre-charging of the capacitor 11. However, within the scope of electric vehicles, measures are generally taken to ensure that the batteries are not completely discharged. In fact, a total discharge of the battery may be harmful to the battery and may reduce the service life thereof and the number of possible recharges. Thus, car manufacturers tend to use devices that avoid total discharge of the battery.

The first step 101 of the method concerns the connection of the electric device 1 to the power source 5, for example via a charging cable 26. The switches 27 are initially open during this connection.

The second step 102 concerns the pre-charging of the capacitor 11 to a predetermined value. This predetermined value typically corresponds to a voltage greater than or equal to the voltage obtained at the terminals of the capacitor 11 during the charging of the battery 21 by the power source 5. By pre-charging the capacitor 11 prior to the connection to the power source 5, it is possible to avoid the appearance of overcurrents. Thus, this value is dependent on the properties (delivered voltage, mono-phase or three-phase, etc.) of the power source 5 to which the electric device 1 is connected. The predetermined value is therefore preferably adapted depending on the power source 5 used. To this end, a device for detecting the properties of the power source 5 can be used, said device utilizing, for example, a communication protocol between the electric device 1 and the power source 5 that would allow the power source 5 to communicate its properties to the electric device 1. However, in order to simplify the electric device 1 in the case where different power sources are used, the most unfavorable case may be selected by default, that is to say the power source for which the voltage at the terminals of the capacitor during charging of the accumulation means is greatest. For example, with a three-phase power source of 230 V, the maximum voltage obtained at the capacitor is 230*√2*√3=564 V. It is therefore necessary to pre-charge the capacitor 11 to a voltage greater than or equal to 564 V in order to avoid the overcurrents. For example, a voltage of 600 V may be considered and this voltage will be applied in all cases. The capacitor 11 is then pre-charged from the battery to a voltage of 600 V, this voltage being obtained thanks to the voltage converter 13, which is configured in order to provide the predetermined value, here 600 V, to the capacitor 11. The capacitor 11 can be pre-charged automatically by the vehicle, for example by processing means such as a microprocessor, said means being connected to detection means configured to detect the connection of the device 1 to the power source 5.

The third step 103 corresponds to the closure of the switches 27, which causes the electrical connection between the phases 15 of the electric motor 17 and the power source 5. This step can be performed automatically by the vehicle, for example by the processing means connected to detection means configured to detect the level of charge of the capacitor 11. Thus, the processing means order the closure of the switches 27 once the pre-charging of the capacitor 11 is complete.

The fourth step 104 corresponds to the charging of the battery 21. In fact, with the closure of the switches 27 in step 103, the alternating voltage provided by the power source 5 is transmitted to the inductors 15 of the rectifier 19. The rectifier 19 is then configured to convert the alternating voltage provided by the power source 5 into direct voltage. The direct voltage provided at the output the rectifier 19 is then lowered to the nominal voltage of the battery 21 by the direct voltage converter 13 so as to allow the transfer of charge between the power source 5 and the battery 21. The rectifier 19 and the voltage converter 13 are controlled for example by the processing means.

The fifth step 105 concerns the disconnection of the device 1 from the power source 5, in particular the disconnection of the charging cable 26, when the charging of the battery 21 is complete. It should be noted that it is not necessary for the battery 21 to be completely recharged in order to conclude the recharging. The disconnection can be detected such that the processing means authorize the power supply of the electric motor 17 by the battery 21 via the control of the voltage converter 13 and of the rectifier 19 in accordance with the commands of the user.

In order to better understand the different aspects of the present invention, an example of use of a motor vehicle 100 shown in FIG. 5 will now be described in detail. The vehicle 100 comprises the electric device 1 in accordance with an embodiment of the present invention, and the vehicle 100 comprises an electric motor 17 of which the phases 15 are at middle points. The electric motor 17 is connected to an electric device 1 as described above comprising a voltage converter 13 connected to the battery 21, a capacitor connected to the voltage converter 13, and an H-bridge converter 19 connected to the capacitor 11. With traction, the converter 19 can supply power to the electric motor 17 from the battery 21. The vehicle 100 also comprises a charging cable 26, which makes it possible to connect the middle points of the phases 15 of the electric motor 17 to the terminals of a plug 29 arranged at the other end of the charging cable 26. The charging cable 26 comprises a switch box containing switches 27 that are by default initially open during an operation of charging of the battery 21. The battery 21 is configured to function between a minimum level of charge Vₘᵢₙ and a maximum level of charge Vmax. The minimum level of charge Vₘᵢₙ corresponds to a level of charge Vₘᵢₙ₁, below which the battery is worn out prematurely, supplemented by a level of charge Vₘᵢₙ₂ corresponding to the energy necessary to charge the capacitor 11. If the level of charge of the battery reaches this minimum threshold, the battery ceases to supply power to the electric motor 17 of the vehicle 100. Thus, when the level of charge approaches this minimum level, the user of the vehicle 100 must find a power source capable of recharging the battery. This power source is for example a dedicated charging terminal 31 comprising a plug 33 that is complementary to the plug 29 of the charging cable 26. The dedicated charging terminal 31 for example delivers a three-phase alternating voltage of 230 V. In order to recharge his battery 21, the user parks his vehicle 100 close to the dedicated charging terminal 31 and connects the charging cable 26 to the charging terminal 31. The connection of the charging cable 26 to the charging terminal 31 is detected by a processing means, such as the electronic management system of the vehicle 100. The processing means then controls the voltage converter 13 so as to charge the capacitor to a voltage of 600 V. When the capacitor is charged the processing means then orders the closure of the switches 27, which makes it possible to supply power to the phases 15 via the charging terminal 31. The H-bridge converter 19 and the voltage converter 13 are then configured to transfer the charge received from the charging terminal to the battery 21. When the battery 21 is fully charged, the processing means indicates to the user that the battery 21 is recharged and opens the switches 27. The user then disconnects the charging cable 26 and can again use his vehicle 100, the motor then being powered by the charged battery 21.

Thus, the pre-charging of the capacitor makes it possible to obtain a sinusoidal absorption over the current delivered by the power source 5 prior to the start of the charge transfer between the power source and the accumulation means, which makes it possible to avoid the overcurrents. The absence of overcurrents makes it possible to maximize the service life of the capacitor and to avoid the triggering of a circuit breaker connected to the power source 5. In addition, the use of the accumulation means and the voltage converter to pre-charge the capacitor also makes it possible to limit the number of components necessary for recharging the accumulation means.

Of course, the invention is not limited to the examples described. In particular, the method has been described for a device in which the inductors are also the phases of the motor. However, the inductors could be dedicated only to the rectifier.

In addition, the connection means could be connected to the windings of the phases of the motor by points other than the middle points of the windings. For example, the connection means can be connected to a phase via one of the terminals thereof as disclosed for example in application FR 2938711 in the name of the applicant.

The method is not limited to a method for transferring a charge from an alternating power source. The method for transferring a charge comprising a pre-charging of the capacitor could be implemented from a direct power source as disclosed for example in application FR2973963 in the name of the applicant.

FIG. 6 illustrates another embodiment of the device according to the invention. The example shown in FIG. 6 differs in particular from that shown in FIG. 2 in that it contains a second DC/DC voltage converter 14 and second accumulation means 22. The second voltage converter 14 is connected between the first accumulation means 21 and the first voltage converter 13. In particular, a first terminal of the second converter 14 is connected to the first terminals of the first accumulation means 21 and of the first converter 13, and a second terminal of the converter 14 is connected to the second terminals of the first accumulation means 21 and of the first converter 13.

The second accumulation means are formed in particular by a rechargeable battery 22, referred to as a second rechargeable battery. In the example illustrated in FIG. 6, the second battery 22 is intended in particular for an application different from that of the first battery 21. The first battery 21 is a high-voltage battery intended to deliver a voltage for example between 180 and 500 V, in particular equal to 400 V; whereas the second battery 22 is a low-voltage battery intended to deliver for example a voltage between 9 and 16 V, in particular equal to 12 V. During the lifetime of the vehicle the first rechargeable battery 21 is intended, inter alia, to supply power to the phases 15 of the motor 17 during traction of the vehicle by the motor. The second rechargeable battery is intended to supply power to other electric consumers of the vehicle, said consumers being different from the electric motor 17, for example wipers or a unit for lighting the passenger compartment of the vehicle.

The second voltage converter 14 is configured to deliver, on the basis of the energy available in the second rechargeable battery 22, an intermediate voltage that is in particular equal to the voltage at the terminals of the first battery 21. The energy output from the second battery 22 and converted by the second converter 14 is then used by the first converter 13 in order to obtain the pre-charging of the capacitor 11. The second voltage converter 14 and the second battery 22 thus contribute to the pre-charging of the capacitor with the first battery 21. Thus, the second converter 14 and the second battery 22 are provided as complement to the first battery 21 and make it possible to reduce the pre-charging time and/or to supplement the voltage delivered to the capacitor 11 during pre-charging.

In a method according to the invention using a device according to this embodiment the capacitor 11 in the pre-charging step 102 is also pre-charged from the second battery 22. The second voltage converter 22 increases the voltage delivered by the second battery 22 to the intermediate voltage. The first converter 13 then increases this intermediate voltage in order to provide the predetermined pre-charge value of the capacitor 11.

The second converter 14 may comprise a circuit similar to that of the first converter 13, in particular with component parameters suitable for application thereof at low voltages. The second converter 14 for example is a reversible converter that can convert a voltage of the second battery 22 into a higher voltage in order to deliver this to the second battery 21 and/or to the first converter 13; and that can, conversely, convert a high-voltage, output for example by the first battery 21 and/or the first converter 13, into a lower voltage in order to power the second battery 22.

FIG. 7 illustrates another device according to the invention. This device will be described by highlighting the differences thereof in relation to the device shown in FIG. 6. The device comprises a switch 28 between on the one hand the first battery 21 and on the other hand the first converter 13 and second converter 14. This switch 28 for example is a transistor or an electromechanical relay. Thanks to this switch 28, the first battery 21 can be disconnected from other parts of the device, and the capacitor 11 can be pre-charged from just the second battery 22. Thus, the capacitor 11 can be pre-charged even in situations in which the first battery 13 has an excessively low charge, for example close to a level of charge below which the battery 13 would degrade if the level of charge thereof were to continue to decrease.

In a method according to the invention using the device shown in FIG. 7, the switch 28 is open prior to the pre-charging step 102, and in particular after the step 101 of connection of the electric device to the power source 5. In the pre-charging step 102, the capacitor is pre-charged from just the second battery 22. Because the first battery 27 is disconnected from other parts of the device 1, it is not involved in the pre-charging of the capacitor 11. Then, in step 103, the switch 28 can be closed in order to allow the charging of the first accumulation means 21 from the power source 5.

1. A method for transferring a charge from a power source to accumulation means of an electric device of a motor vehicle, said electric device comprising:
a voltage converter connected to the accumulation means,
a capacitor connected to the voltage converter,
connection means of the electric device, said connection means being intended for connection to the power source, and
a second voltage converter connected between the first accumulation means and the first converter and to second accumulation means,
the method comprising:
a step of connecting means for connection to the power source in order to enable a transfer of charge to the accumulation means; and
a step of pre-charging the capacitor to a predetermined voltage on the basis of the voltage provided by the accumulation means via the voltage converter, said pre-charging step being prior to the transfer of charge of the power source to the accumulation means,
wherein the second voltage converter, during said pre-charging step, delivers, on the basis of the voltage provided by the second accumulation means, an intermediate voltage on the basis of which the first voltage converter pre-charges the capacitor to said predetermined voltage.

2. The transfer method as claimed in claim 1, wherein the predetermined voltage value corresponds to a voltage greater than or equal to the voltage obtained at the terminals of the capacitor during the charging of the accumulation means by the power source.

3. The transfer method as claimed in claim 1, wherein the electric device also comprises a rectifier and inductors, said rectifier being connected to the capacitor and to the inductors, said inductors being connected to the connection means.

4. The transfer method as claimed in claim 3, wherein the switches of the rectifier are open during the pre-charging step.

5. The transfer method as claimed in claim 3, wherein the rectifier is an H-bridge converter, and wherein the inductors comprise the phases of an electric motor.

6. An electric device of a motor vehicle comprising:
accumulation means,
a voltage converter connected to the accumulation means,
a capacitor connected to the voltage converter,
connection means of the electric device, said connection means being configured for connection to a power source to enable a transfer of charge from said power source to the accumulation means, and
a second voltage converter connected between the accumulation means and the first converter and to second accumulation means,
wherein the voltage converter is configured to pre-charge the capacitor to a predetermined voltage on the basis of the voltage provided by the accumulation means, prior to the transfer of charge from said power source to the accumulation means, and in that the second voltage converter is configured to deliver, on the basis of the voltage provided by the second accumulation means, an intermediate voltage on the basis of which the first voltage converter pre-charges the capacitor to said predetermined voltage.

7. The electric device as claimed in claim 6, wherein the predetermined voltage corresponds to a voltage greater than or equal to the voltage established at the terminals of the capacitor as the accumulation means are charged by the power source.

8. The electric device as claimed in claim 6, also comprising a rectifier and inductors, said rectifier being connected to the capacitor and to the inductors, said inductors being connected to the connection means.

9. The electric device as claimed in claim 8, wherein the rectifier is an H-bridge converter, and wherein the inductors comprise the phases of an electric motor.

10. The electric device as claimed in claim 9, wherein the bridges of the converter comprise a first and a second branch, which are parallel, and a transverse branch, said parallel branches comprising two switches arranged in series, and said transverse branch comprising one of said inductors and connecting the middle points of said first and second parallel branches.

11. The electric device as claimed in claim 9, wherein the phases of the motor comprise a winding at the middle point, and wherein the connection means are connected at the middle points of the windings of the phases of the electric motor.

12. The electric device as claimed in claim 6, wherein the voltage converter is a DC/DC voltage converter and comprises two switches arranged in series between a first and a second input terminal, the middle point arranged between the two switches being connected to a first terminal of an inductor of which the second terminal is connected to a first output terminal, a second output terminal being connected to the second input terminal and to ground.

13. The electric device as claimed in claim 12, wherein the accumulation means comprise a positive terminal connected to the first output terminal of the voltage converter and a negative terminal connected to the second output terminal of the voltage converter.

14. The electric device as claimed in claim 12, wherein the capacitor is branched between the first and the second input terminal of the voltage converter.

15. The electric device as claimed in claim 10, wherein the switches comprise a transistor with a diode arranged in anti-parallel.

16. The electric device as claimed in claim 6, wherein the first accumulation means are intended to supply power to an electric motor and the second accumulation means are intended to supply power to one or more electric consumers different from said electric motor.
